(19) United States
(12) Patent Application Publication
(10) Pub. No.: US 2010/0205487 A1
(43) Pub. Date: Aug. 12, 2010

(54) INFORMATION PROCESSING APPARATUS, INFORMATION PROCESSING METHOD, PROGRAM AND INFORMATION PROCESSING SYSTEM

(75) Inventor: Tsuyoshi MASATO, Kanagawa (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: Sony Corporation, Tokyo (JP)

(21) Appl. No.: 12/687,460

(22) Filed: Jan. 14, 2010

(30) Foreign Application Priority Data
Feb. 10, 2009 (JP) 2009-028335

(51) Int. Cl. G06F 15/16; G06F 11/07

(52) U.S. Cl. 714/57; 709/227; 714/E11.025

(57) ABSTRACT

There is provided an information processing apparatus including an application processing unit that executes open processing by calling a socket processing unit, causes connect processing to start by specifying an IP address and a port number of the other apparatus stored in a storage unit as a connection destination of the socket and also specifying a non-block mode, causes select processing to start by specifying to monitor whether the socket becomes writable with a timeout function, and determines whether information indicating that the socket has become writable is output from the socket processing unit before the timeout occurs.

### BACKGROUND OF THE INVENTION

1. Field of the Invention

The present invention relates to an information processing apparatus, an information processing method, a program, and an information processing system.

2. Description of the Related Art

In recent years, firewalls are widely used to prevent invalid access. A firewall is a system to protect a network inside an organization from attacks and invalid access from untrustworthy networks such as the Internet. A function called packet filtering is known as a technology used for the firewall. The packet filtering is a function mainly corresponding to the Internet layer of TCP (Transmission Control Protocol)/IP (Internet Protocol) model and selectively decides passage or discarding of a packet based on information such as the source or destination of the packet and IP address/port number/communication direction (see, for example, Japanese Patent Application Laid-Open No. 2007-325293).

Packet filtering executed in a specific service configured and realized by a server/client model provided with a server and clients will be considered. In the server/client model in information communication, the IP address and port number on the server side are known before communication is started. On the client side, by contrast, while the IP address is known, the port number is not known. That is, the port number on the client side is decided after communication is established. Therefore, when packet filtering is executed in the communication, it is easily imagined to use the IP address and port number on the server side. No issue is raised by this method when packet filtering is executed on the server side.

### SUMMARY OF THE INVENTION

However, an issue may arise on the client side. More specifically, when packet filtering on the client side detects an invalid packet and discards the packet, such an issue that no response from the server appears to arrive at an application program on the client side can arise. Thus, an issue that processing by the application program on the client side stops (also called a “block operation”) before a timeout of communication (timeout in TCP) occurs. The suspending time is generally from three to five minutes where the timeout in TCP (also called “TCP timeout”) occurs. Moreover, changing the setting time before a TCP timeout may not be allowed.

In light of the foregoing, it is desirable to provide a novel and improved technology capable of, if the filtering function to discard packets from an invalid communication partner by using the IP address and port number of the communication partner is provided, avoiding a block operation generated before a TCP timeout occurs when communication is started with a communication partner without changing the setting time before the TCP timeout occurs.

According to an embodiment of the present invention, there is provided an information processing apparatus including a communication unit capable of transmitting/receiving packets to/from another apparatus via a network, a storage unit that stores an IP address and a port number of the other apparatus, a packet filter processing unit that, when the communication unit receives a packet, discards or allows to pass the packet by executing filtering on the received packet, a socket processing unit that is capable of accepting input of the packet allowed to pass by the packet filter processing unit and when open processing on a socket is executed by a calling source, executes connect processing according to a mode specified for a connection destination specified by the calling source, executes select processing according to the mode specified by the calling source and also outputs a result of the select processing to provide communication based on the socket to the calling source and an application processing unit that executes the open processing by calling the socket processing unit, causes the connect processing to start by specifying the IP address and the port number of the other apparatus stored in the storage unit as the connection destination of the socket and also specifying a non-block mode, causes the select processing to start by specifying to monitor whether the socket becomes writable with a timeout function, and determines whether information indicating that the socket has become writable is output from the socket processing unit before the timeout occurs.

The application processing unit may accept input of information indicating that the connect processing failed from the socket processing unit after the connect processing being caused to start by specifying the socket to the non-block mode and may cause the select processing to start by ignoring the information.

The socket processing unit may output information indicating that the connect processing failed to the application processing unit and also continue the connect processing in a background after the connect processing failed.

According to the present invention, as described above, if the filtering function to discard packets from an invalid communication partner by using the IP address and port number of the communication partner is provided, a block operation generated before a TCP timeout occurs can be avoided when communication is started with a communication partner without changing the setting time before the TCP timeout occurs.

### BRIEF DESCRIPTION OF THE DRAWINGS

FIG. 1 is a block diagram showing a functional configuration of an information processing system;

FIG. 2 is a diagram showing a relationship between each functional block of the information processing system and a TCP/IP model;

FIG. 3 is a block diagram showing a hardware configuration of a client device;

FIG. 4 is a block diagram showing the hardware configuration of a server device;

FIG. 5 is a flow chart showing an operation of a general server device;

FIG. 6 is a flow chart showing the operation of a general client device; and

FIG. 7 is a flow chart showing the operation of the client device according to the present embodiment.

### DETAILED DESCRIPTION OF THE EMBODIMENTS

Hereinafter, preferred embodiments of the present invention will be described in detail with reference to the appended drawings. Note that, in this specification and the appended drawings, structural elements that have substantially the same function and structure are denoted with the same reference numerals, and repeated explanation of these structural elements is omitted.
1. First Embodiment
1-1. Functional Configuration of Information Processing System
1-2. Relationship Between Each Functional Block and TCP/IP Model
1-3. Hardware Configuration of Client Device
1-4. Hardware Configuration of Server Device
1-5. Operation of General Server Device (when Both Devices are Valid)
1-6. Operation of General Server Device (when Client Device is Invalid)
1-7. Operation of General Client Device (when Both Devices are Valid)
1-8. Operation of General Client Device (when Server Device is Invalid)
1-9. Operation of Client Device According to the First Embodiment of the Present Invention
2. Modification of the Present Embodiment
3. Summary

### 1. First Embodiment

The first embodiment of the present invention will be described.

[1-1. Functional Configuration of Information Processing System]

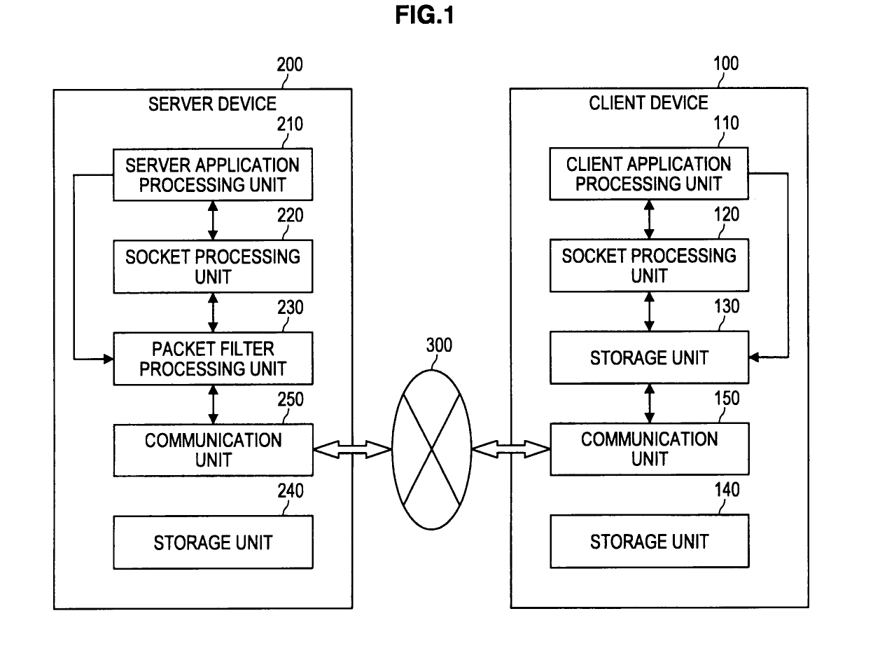

The functional configuration of an information processing system according to the first embodiment of the present invention will be described. FIG. 1 is a block diagram showing the functional configuration of an information processing system according to the first embodiment of the present invention. The functional configuration of an information processing system according to the first embodiment of the present invention will be described below using FIG. 1.

As shown in FIG. 1, the information processing system according to the first embodiment of the present invention is configured by a client device 100 as an example of an information processing apparatus and a server device 200 as an example of an information providing apparatus being connected by a network 300 such as the Internet. The server device 200 functions mainly as a device on the information providing side and the client device 100 mainly as a device on the information processing side.

The client device 100 includes a client application processing unit 110, a socket processing unit 120, a packet filter processing unit 130, a storage unit 140, and a communication unit 150.

The communication unit 150 is constituted by a communication apparatus and the like and can transmit/receive packets to/from the server device 200 as an example of another apparatus via the network 300.

The storage unit 140 is used to store the IP address and port number of the server device 200 as an example of the other apparatus. The storage unit 140 is constituted by, for example, a RAM (Random Access Memory) and primarily stores a program used for execution by a CPU (Central Processing Unit) and parameters that change appropriately during execution thereof.

The packet filter processing unit 130 is constituted by, for example, the CPU, a ROM (Read Only Memory), the RAM and the like. When the communication unit 150 receives a packet, the packet filter processing unit 130 discards the packet or allows the packet to pass by executing filtering on the received packet.

The socket processing unit 120 is constituted by, for example, the CPU, ROM, RAM and the like. The socket processing unit 120 can accept input of a packet allowed to pass by the packet filter processing unit 130. When open processing on a socket is executed by a calling source, the socket processing unit 120 executes connect processing on a connection destination specified by the calling source according to the specified mode. Then, the socket processing unit 120 executes select processing according to the mode specified by the calling source and outputs a result of the select processing to provide the result to the calling source of communication based on the socket.

The client application processing unit (application processing unit) 110 is constituted by, for example, the CPU, ROM, RAM and the like. The client application processing unit 110 executes open processing by calling the socket processing unit 120. Then, the client application processing unit 110 causes connect processing to start by specifying the IP address and port number of the server device 200 as an example of the other apparatus stored by the storage unit 140 as the socket connection destination and also a non-block mode. Then, the client application processing unit 110 causes select processing to start by specifying to monitor whether the socket becomes writable with a timeout function. The client application processing unit 110 determines whether information indicating that the socket has become writable is output from the socket processing unit 120 before the timeout occurs.

After causing the connect processing to start by specifying the non-block mode for the socket, the client application processing unit 110 accepts input of information indicating that the connect processing failed from the socket processing unit. However, the client application processing unit 110 causes the select processing to start by ignoring this information.

If the connect processing failed, the socket processing unit 120 outputs information indicating that the connect processing failed to the application processing unit and also continues to perform the connect processing in the background.

The server device 200 includes a server application processing unit 210, a socket processing unit 220, a packet filter processing unit 230, a storage 240, and a communication unit 250.

The communication unit 250 is constituted by a communication apparatus and the like and can transmit/receive packets to/from the client device 100 via the network 300.

The storage unit 240 is used to store the IP address and port number of the server device 200 itself. The storage unit 240 is constituted by, for example, the RAM and primarily stores a program used for execution by a CPU and parameters that change appropriately during execution thereof.

The packet filter processing unit 230 is constituted by, for example, the CPU, ROM, RAM and the like. When the communication unit 250 receives a packet, the packet filter processing unit 230 discards the packet or allows the packet to pass by executing filtering on the received packet.

The socket processing unit 220 is constituted by, for example, the CPU, ROM, RAM and the like. The socket processing unit 220 can accept input of a packet allowed to pass by the packet filter processing unit 230. When open processing on a socket is executed by a calling source, the socket processing unit 220 executes listening processing to wait for an access from the client device 100 and before executing accept processing to accept the access from the client device 100.

The server application processing unit (application processing unit) 210 is constituted by, for example, the CPU, ROM, RAM and the like. The server application processing unit 210 executes open processing by calling the socket processing unit 220. Then, the server application processing unit 210 causes the listening processing to start before causing the accept processing to start.

In the foregoing, the functional configuration of an information processing system according to the first embodiment of the present invention has been described. Next, the relationship between each functional block of an information processing system according to the first embodiment of the present invention and the TCP/IP model will be described.

[1-2. Relationship Between Each Functional Block and TCP/IP Model]

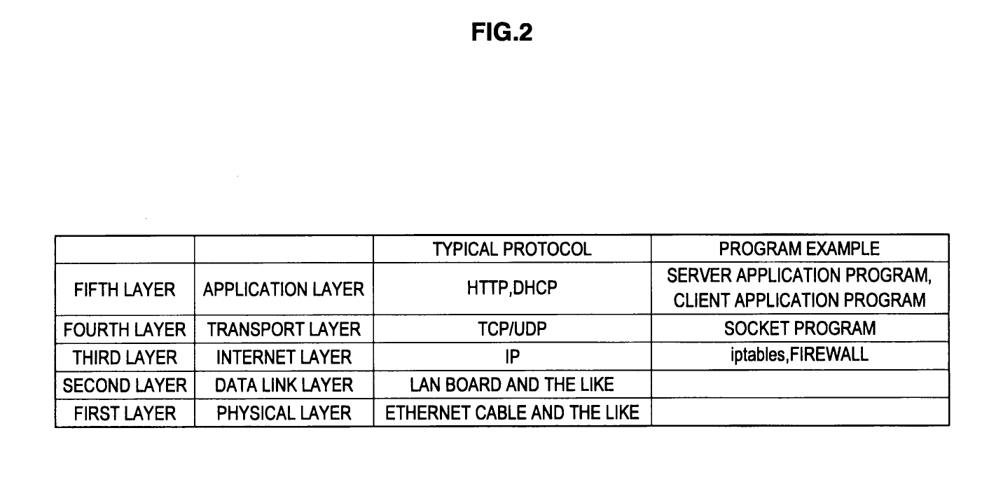

The relationship between each functional block of an information processing system according to the first embodiment of the present invention and the TCP/IP model will be described. FIG. 2 is a diagram showing the relationship between each functional block of an information processing system according to the first embodiment of the present invention and the TCP/IP model. The relationship between each functional block of an information processing system according to the first embodiment of the present invention and the TCP/IP model will be described below using FIG. 2.

As shown in FIG. 2, the packet filter processing units 130 and 230 realize the function of the third Internet layer. The socket processing units 120 and 220 realize the function of the fourth transport layer. The server application processing unit 210 and the client application processing unit 110 realize the function of the fifth application layer. For the first physical layer and second data link layer, a representation as a functional block is omitted.

In the foregoing, the relationship between each functional block of an information processing system according to the first embodiment of the present invention and the TCP/IP model has been described. Next, the hardware configuration of a client device according to the first embodiment of the present invention will be described.

[1-3. Hardware Configuration of Client Device]

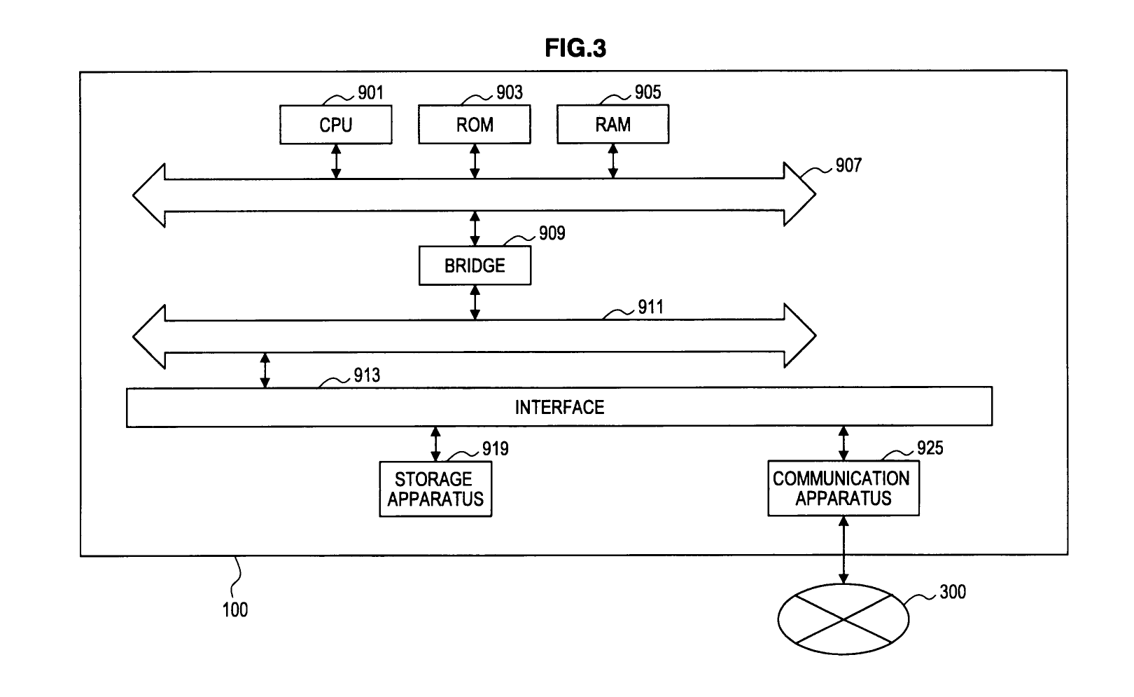

Next, the hardware configuration of a client device according to the first embodiment of the present invention will be described. FIG. 3 is a block diagram showing the hardware configuration of a client device according to the first embodiment of the present invention. The hardware configuration of a client device according to the first embodiment of the present invention will be described below using FIG. 3.

The client device 100 mainly includes a CPU 901, a ROM 903, a RAM 905, a host bus 907, a bridge 909, an external bus 911, an interface 913, a storage apparatus 919, and a communication apparatus 925.

The CPU 901 functions as an arithmetic processing unit and a controller and controls overall operations in the client device 100 or a part of the operations in the same according to various programs stored in the ROM 903, the RAM 905, or the storage apparatus 919. The ROM 903 stores programs used by the CPU 901, operation parameters and the like. The RAM 905 primarily stores a program used for execution by the CPU and parameters that change appropriately during execution thereof. These components are mutually connected by the host bus 907 constituted by an internal bus such as a CPU bus.

The host bus 907 is connected to the external bus 911 such as a PCI (Peripheral Component Interconnect/Interface) bus via the bridge 909.

The storage apparatus 919 is an apparatus for data storage constituted as an example of the storage unit of the client device 100 and is constituted by, for example, a magnetic storage device such as an HDD (Hard Disk Drive), semiconductor storage device, optical storage device, magneto-optical storage device or the like. The storage apparatus 919 stores programs executed by the CPU 901, various kinds of data, and acoustic signal data and image signal data acquired from outside.

The communication apparatus 925 is a communication interface constituted by, for example, a communication device for connecting to the network 300. The communication apparatus 925 is, for example, a communication card for wire or wireless LAN (Local Area Network), Bluetooth, or WUSB (Wireless USB), router for optical communication, router for ADSL (Asymmetric Digital Subscriber Line), or modem for various kinds of communication. The communication apparatus 925 can, for example, transmit/receive an acoustic signal to/from the Internet or other communication devices. The network 300 connected to the communication apparatus 925 is constituted by a network connected by wire or by radio or the like and may be, for example, the Internet.

In the foregoing, an example of the hardware configuration that can realize the function of the client device 100 according to each embodiment of the present invention. Each of the above components may be constituted by using general members or hardware specialized for the function of each component. Therefore, the hardware configuration to be used can appropriately be changed depending on the technical level when the present embodiment is carried out.

In the foregoing, the hardware configuration of a client device according to the first embodiment of the present invention has been described. Next, the hardware configuration of a server device according to the first embodiment of the present invention will be described.

[1-4. Hardware Configuration of Server Device]

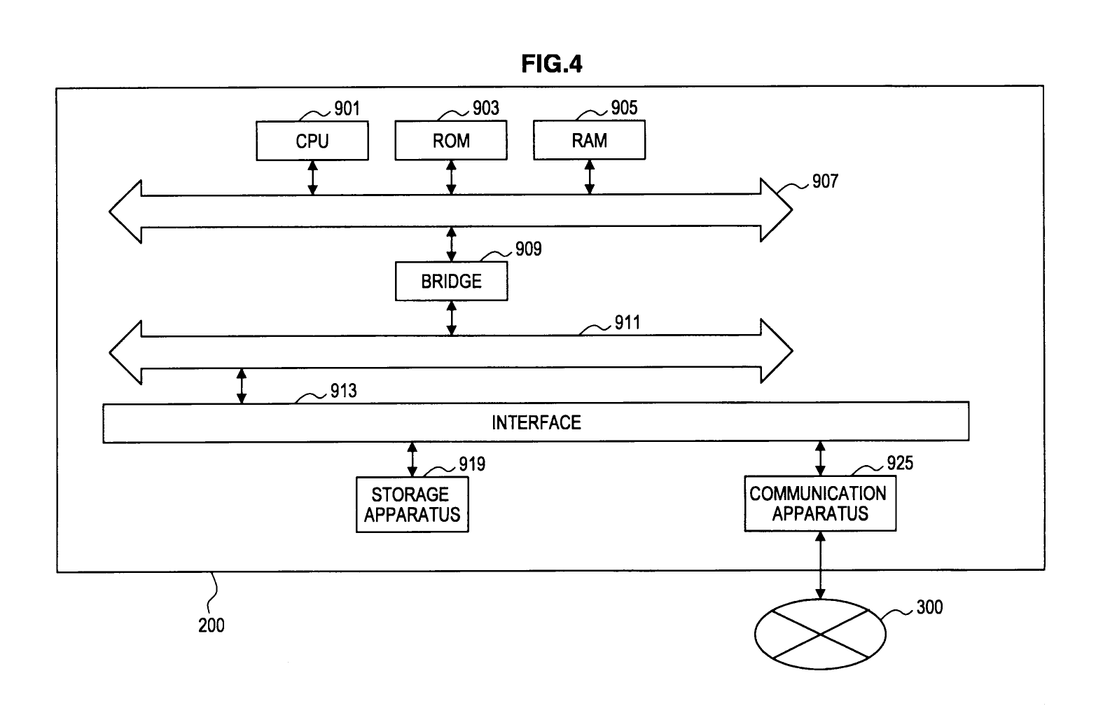

Next, the hardware configuration of a server device according to the first embodiment of the present invention will be described. FIG. 4 is a block diagram showing the hardware configuration of a server device according to the first embodiment of the present invention. The hardware configuration of a server device according to the first embodiment of the present invention will be described below using FIG. 4.

As shown in FIG. 4, hardware of the server device 200 can be constituted like that of the client device 100. Therefore, a detailed description of hardware of the server device 200 is omitted.

In the foregoing, the hardware configuration of a server device according to the first embodiment of the present invention has been described. Next, an operation of a general server device (when both devices are valid) will be described.

[1-5. Operation of General Server Device (When Both Devices Are Valid)]

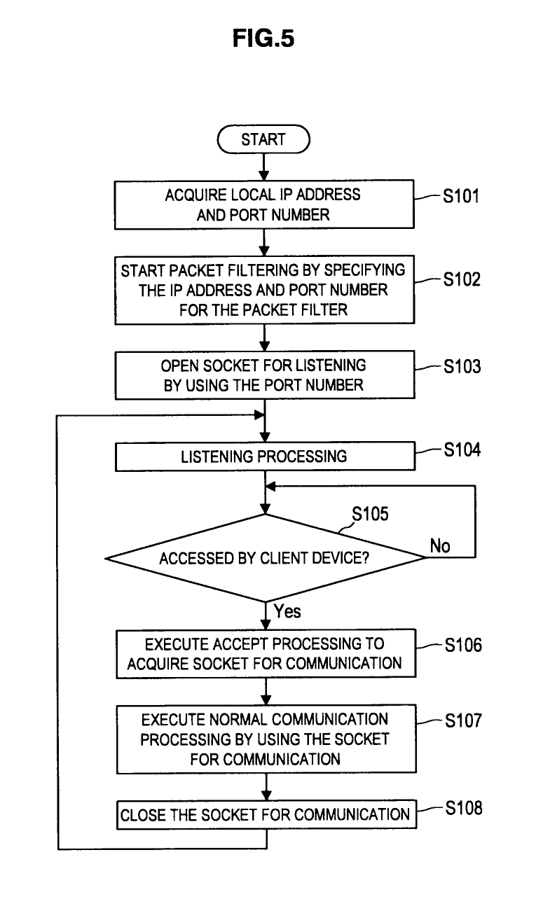

Next, an operation of a general server device (when both devices are valid) will be described. FIG. 5 is a flow chart showing an operation of a general server device. The operation of a general server device (when both devices are valid) will be described below using FIG. 5.

The server application processing unit 210 acquires the IP address and port number of the local device from the storage 240 (step S101). The server application processing unit 210 causes the packet filter processing unit 230 to start packet filtering by specifying the IP address and port number for the packet filter (step S102). The server application processing unit 210 opens a socket for listening by using the port number (step S103). The server application processing unit 210 causes the socket processing unit 220 to start listening processing (step S104).

The server application processing unit 210 determines whether the client device 100 has made access (step S105). If the server application processing unit 210 determines that the client device 100 has made no access (“No” at step S105), the server application processing unit 210 returns to step S105. If the server application processing unit 210 determines that the client device 100 has made access (“Yes” at step S105), the server application processing unit 210 causes the socket processing unit 220 to start accept processing to acquire a socket for communication (step S106). Then, the server application processing unit 210 executes normal communication processing by means of the socket for communication (step S107) and closes the socket for communication (step S108) before returning to step S104.

In the foregoing, the operation of a general server device (when both devices are valid) has been described. Next, an operation of a general server device (when a client device is invalid) will be described.

[1-6. Operation of General Server Device (When Client Device Is Invalid)]

Next, an operation of a general server device (when a client device is invalid) will be described. The operation of a general server device (when a client device is invalid) will be described below using FIG. 5.

The server application processing unit 210 acquires the IP address and port number of the local device from the storage 240 (step S101). The server application processing unit 210 causes the packet filter processing unit 230 to start packet filtering by specifying the IP address and port number for the packet filter (step S102). The server application processing unit 210 opens a socket for listening by using the port number (step S103). The server application processing unit 210 causes the socket processing unit 220 to start listening processing (step S104).

The server application processing unit 210 determines whether the client device 100 has made access (step S105). If the server application processing unit 210 determines that the client device 100 has made no access (“No” at step S105), the server application processing unit 210 returns to step S105. If the client device 100 is invalid, access from the client device 100 is discarded by the packet filter processing unit 230. Therefore, if the client device 100 is invalid, the server device 200 does not recognize access from the invalid client device 100 and thus, no particular issue is assumed.

In the foregoing, the operation of a general server device (when a client device is invalid) has been described. Next, an operation of a general client device (when both devices are valid) will be described.

[1-7. Operation of General Client Device (When Both Devices Are Valid)]

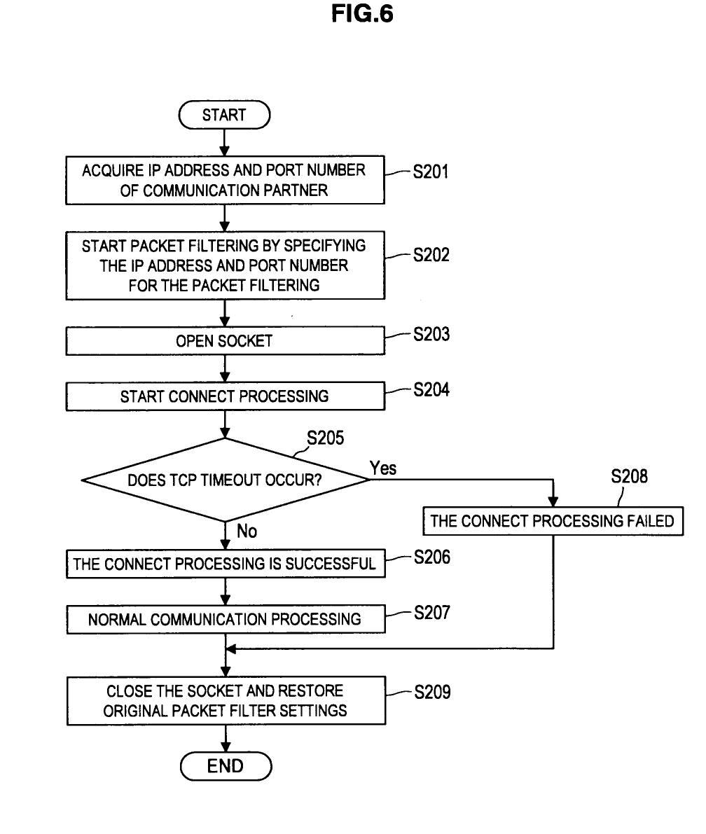

Next, an operation of a general client device (when both devices are valid) will be described. The operation of a general client device (when both devices are valid) will be described below using FIG. 6.

The client application processing unit 110 acquires the IP address and port number of a remote partner (the server device 200) from the storage unit 140 (step S201). The client application processing unit 110 causes the packet filter processing unit 130 to start packet filtering by specifying the IP address and port number for the packet filter (step S202). The client application processing unit 110 opens the socket (step S203). The client application processing unit 110 causes the socket processing unit 120 to start connect processing (step S204).

Since the remote partner is valid, no TCP timeout occurs (“No” at step S205), the connect processing is successful (step at step S206), and the client application processing unit 110 executes normal communication processing (step S207), closes the socket, and restores original packet filter settings (step S209) before finishing processing.

In the foregoing, the operation of a general client device (when both devices are valid) has been described. Next, an operation of a general client device (when a server device is invalid) will be described.

[1-8. Operation of General Client Device (when Server Device is Invalid)]

Next, an operation of a general client device (when a server device is invalid) will be described. The operation of a general client device (when a server device is invalid) will be described below using FIG. 6.

The client application processing unit 110 acquires the IP address and port number of a remote partner (the server device 200) from the storage unit 140 (step S201). The client application processing unit 110 causes the packet filter processing unit 130 to start packet filtering by specifying the IP address and port number for the packet filter (step S202). The client application processing unit 110 opens the socket (step S203). The client application processing unit 110 causes the socket processing unit 120 to start connect processing (step S204).

Here, if the server device 200 is invalid, a reply from the server device 200 is discarded by the packet filter processing unit 130 and thus, processing stops. Therefore, a TCP timeout occurs (“Yes” at step S205). After the timeout occurs, the client application processing unit 110 determines that the connect processing failed (step S208) before proceeding to step S209, but a wait time of about three minutes is generally necessary to proceed from steps S205 to S209. The client application processing unit 110 closes the socket and restores original packet filter settings (step S208) before finishing processing. In this example, the client device 100 attempts to access the server device 200, but is forced to wait in a state in which no reply is received from the server device 200. Therefore, there is an issue that a user of the client device 100 may be forced to feel stress.

In the foregoing, the operation of a general client device (when a server device is invalid) has been described. Next, an operation of a client device according to the first embodiment of the present invention will be described.

[1-9. Operation of Client Device According to the First Embodiment of the Present Invention]

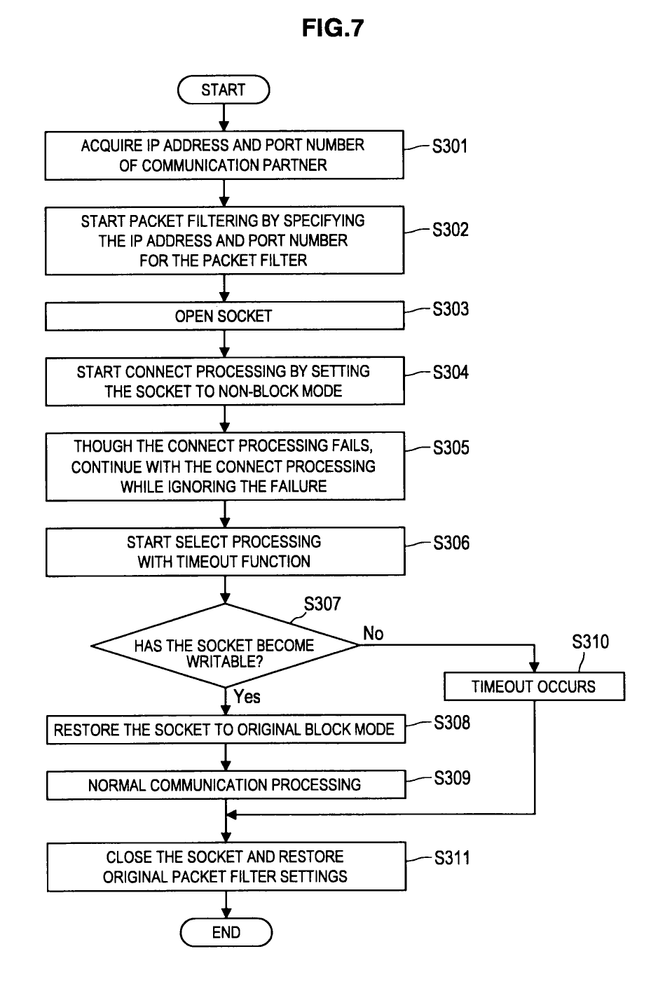

Next, an operation of a client device according to the first embodiment of the present invention will be described. The operation of a client device according to the first embodiment of the present invention will be described below using FIG. 7.

As shown in FIG. 7, the client application processing unit 110 acquires the IP address and port number of a remote partner (the server device 200) from the storage unit 140 (step S301). The client application processing unit 110 causes the packet filter processing unit 130 to start packet filtering by specifying the IP address and port number for the packet filter (step S302). The client application processing unit 110 opens the socket (step S303). The client application processing unit 110 causes the socket processing unit 120 to start connect processing by setting the socket to be the non-block mode (step S304).

At this point, communication is not established and the connect processing fails, but the socket processing unit 120 continues the connect processing while ignoring the failure (step S305). The client application processing unit 110 causes the socket processing unit 120 to start select processing with a timeout function (step S306). The client application processing unit 110 sets the time before a timeout occurs to, for example, about five seconds. The client application processing unit 110 determines whether the socket has become writable (step S307).

If the client application processing unit 110 determines that the socket has become writable (“Yes” at step S307), the client application processing unit 110 determines that the server device 200 is valid and restores the socket to the original block mode (step S308) to perform normal communication processing (step S309) before proceeding to step S311. If the client application processing unit 110 determines that the socket has not become writable (“No” at step S307), a timeout occurs (step S310) and the client application processing unit 110 determines that the server device 200 is invalid before proceeding to step S311. The client application processing unit 110 closes the socket and restores original packet filter settings (step S311) before finishing processing.

While a wait time of about three minutes is common when the server device 200 is invalid, according to the first embodiment, the wait time can be reduced to about five seconds (or can be made still shorter depending on the setting). Accordingly, the stress felt by the user of the client device 100 can be reduced.

In the foregoing, the operation of a client device according to the first embodiment of the present invention has been described.

### 2. Modification of the Present Embodiment

It should be understood by those skilled in the art that various modifications, combinations, sub-combinations and alterations may occur depending on design requirements and other factors insofar as they are within the scope of the appended claims or the equivalents thereof.

### 3. Summary

According to the present embodiment, if the filtering function to discard packets from an invalid communication partner by using the IP address and port number of the communication partner is provided, a block operation generated before a TCP timeout occurs can be avoided when communication is started with a communication partner without changing the setting time before the TCP timeout occurs.

The present application contains subject matter related to that disclosed in Japanese Priority Patent Application JP 2009-28335 filed in the Japan Patent Office on Feb. 10, 2009, the entire content of which is hereby incorporated by reference.

What is claimed is:

1. An information processing apparatus, comprising:
a communication unit capable of transmitting/receiving packets to/from another apparatus via a network;
a storage unit that stores an IP address and a port number of the other apparatus;
a packet filter processing unit that, when the communication unit receives a packet, discards or allows to pass the packet by executing filtering on the received packet;
a socket processing unit that is capable of accepting input of the packet allowed to pass by the packet filter processing unit and when open processing on a socket is executed by a calling source, executes connect processing according to a mode specified for a connection destination specified by the calling source, executes select processing according to the mode specified by the calling source and also outputs a result of the select processing to provide communication based on the socket to the calling source; and
an application processing unit that executes the open processing by calling the socket processing unit, causes the connect processing to start by specifying the IP address and the port number of the other apparatus stored in the storage unit as the connection destination of the socket and also specifying a non-block mode, causes the select processing to start by specifying to monitor whether the socket becomes writable with a timeout function, and determines whether information indicating that the socket has become writable is output from the socket processing unit before the timeout occurs.

2. The information processing apparatus according to claim 1, wherein
the application processing unit accepts input of information indicating that the connect processing failed from the socket processing unit after the connect processing being caused to start by specifying the socket to the non-block mode and causes the select processing to start by ignoring the information.

3. The information processing apparatus according to claim 1, wherein
the socket processing unit outputs information indicating that the connect processing failed to the application processing unit and also continues the connect processing in a background after the connect processing failed.

4. An information processing method performed by an information processing apparatus including:
a communication unit capable of transmitting/receiving packets to/from another apparatus via a network;
a storage unit that stores an IP address and a port number of the other apparatus;
a packet filter processing unit that, when the communication unit receives a packet, discards or allows to pass the packet by executing filtering on the received packet;
a socket processing unit that is capable of accepting input of the packet allowed to pass by the packet filter processing unit and when open processing on a socket is executed by a calling source, executes connect processing according to a mode specified for a connection destination specified by the calling source, executes select processing according to the mode specified by the calling source and also outputs a result of the select processing to provide communication based on the socket to the calling source;
and an application processing unit,
the method comprising the following steps conducted by the application processing unit:
executing the open processing by calling the socket processing unit;
causing the connect processing to start by specifying the IP address and the port number of the other apparatus stored in the storage unit as the connection destination of the socket and also specifying a non-block mode;
causing the select processing to start by specifying to monitor whether the socket becomes writable with a timeout function; and
determining whether information indicating that the socket has become writable is output from the socket processing unit before the timeout occurs.

5. A recording medium in which a program to cause a computer to execute an information processing method by an information processing apparatus including:
a communication unit capable of transmitting/receiving packets to/from another apparatus via a network;
a storage unit that stores an IP address and a port number of the other apparatus;
a packet filter processing unit that that, when the communication unit receives a packet, discards or allows to pass the packet by executing filtering on the received packet;
a socket processing unit that is capable of accepting input of the packet allowed to pass by the packet filter processing unit and when open processing on a socket is executed by a calling source, executes connect processing according to a mode specified for a connection destination specified by the calling source, executes select processing according to the mode specified by the calling source and also outputs a result of the select processing to provide communication based on the socket to the calling source;
and an application processing unit,
the method comprising the steps conducted by the application processing unit:
executing the open processing by calling the socket processing unit;
causing the connect processing to start by specifying the IP address and the port number of the other apparatus stored in the storage unit as the connection destination of the socket and also specifying a non-block mode;
causing the select processing to start by specifying to monitor whether the socket becomes writable with a timeout function; and
determining whether information indicating that the socket has become writable is output from the socket processing unit before the timeout occurs.
